(19) United States
(12) Patent Application Publication
(10) Pub. No.: US 2012/0171646 A1
(43) Pub. Date: Jul. 5, 2012

(54) AUTOMATIC DIET PLANNING METHOD AND MOBILE DEVICE FOR PERFORMING THE SAME

(75) Inventors: Li-Ju Chen, Taipei (TW); Mark Hsiao, Taipei (TW)

(73) Assignee: INTERNATIONAL BUSINESS MACHINES CORPORATION, Armonk, NY (US)

(21) Appl. No.: 13/289,057

(22) Filed: Nov. 4, 2011

(30) Foreign Application Priority Data
Dec. 30, 2010 (TW) 99146949

(51) Int. Cl. G09B 19/00

(52) U.S. Cl. 434/127

(57) ABSTRACT

An automatic diet planning method includes receiving, by a computing device, user input of a nutrition constraint on a type of nutrition; receiving user input of a preference constraint on a type of user preference, wherein the user preference has nothing to do with nutrition; providing to the user a plurality of meal items; pre-determining a nutrition value for each meal item regarding the type of nutrition; pre-determining a preference value for each meal item regarding the user preference; and receiving from the user a selection of at least one planned meal item from the plurality of meal items according to the nutrition constraint and the preference constraint, wherein the planned meal item has the nutrition value and the preference value respectively complying with the nutrition constraint and the preference constraint.

### PRIORITY

This application claims priority to Taiwanese Patent Application No. 99146949, filed 30 Dec. 2010, and all the benefits accruing therefrom under 35 U.S.C. §119, the contents of which in its entirety are herein incorporated by reference.

### BACKGROUND

The present invention relates to an automatic diet planning method and a mobile device for performing the same.

Applications for use in diet planning are increasing in popularity. For example, US-based Daily Burn™ offers two applications, namely Food Scanner and Daily Burn, for use with iPhone™ of Apple™. Also, to carry out personal diet planning, users may inquire about meal nutrition, using a meal nutrition database of the Website (http://dailyburn.com/).

Furthermore, published US patent applications US2008/0034001, US 2008/0033827, and US2009/0234839 also provide some conventional diet planning methods.

### SUMMARY

In an embodiment, an automatic diet planning method includes receiving, by a computing device, user input of a nutrition constraint on a type of nutrition; receiving user input of a preference constraint on a type of user preference, wherein the user preference has nothing to do with nutrition; providing to the user a plurality of meal items; pre-determining a nutrition value for each meal item regarding the type of nutrition; pre-determining a preference value for each meal item regarding the user preference; and receiving from the user a selection of at least one planned meal item from the plurality of meal items according to the nutrition constraint and the preference constraint, wherein the planned meal item has the nutrition value and the preference value respectively complying with the nutrition constraint and the preference constraint.

In another embodiment, a mobile device includes a memory configured to store an application; and a processor configured to access the memory to execute the application, the application implementing a, automatic diet planning method, wherein the method comprises: receiving user input of a nutrition constraint on a type of nutrition; receiving user input of a preference constraint on a type of user preference, wherein the user preference has nothing to do with nutrition; providing to the user a plurality of meal items; pre-determining a nutrition value for each meal item regarding the type of nutrition; pre-determining a preference value for each meal item regarding the user preference; and receiving from the user a selection of at least one planned meal item from the plurality of meal items according to the nutrition constraint and the preference constraint, wherein the planned meal item has the nutrition value and the preference value respectively complying with the nutrition constraint and the preference constraint.

### BRIEF DESCRIPTION OF THE SEVERAL VIEWS OF THE DRAWINGS

Referring to the exemplary drawings wherein like elements are numbered alike in the several Figures:

FIG. 1 is a block diagram of a mobile device according to specific embodiments of the present disclosure; and

FIG. 2 through FIG. 7 are flowcharts of specific embodiments of the present disclosure.

### DETAILED DESCRIPTION

Conventional diet planning entails giving consideration to meal nutrition only. However, for some individuals, the most important factor in deciding on a meal choice is usually taste rather than nutrition. In addition to taste, many people that eat out consider such factors as cost or another person's rating of the food/restaurant. In view of this, embodiments herein, in addition to nutrition, consider a user's preference and location, as well as other factors which are not related to nutrition, for diet planning purposes.

Furthermore, conventional diet planning, such as the aforesaid Food Scanner and Daily Burn, requires inquiring about nutrition-related data of a “specific meal” and then determining whether a nutrition value of the specific meal complies with a default nutrition constraint. In this regard, another embodiment of the present disclosure is characterized by “interactive” and “flexible” diet planning. Given a nutrition constraint, a user takes the initiative in planning an appropriate meal item and, in particular, selects a type of meal item(s), such as a main dish, according to the user's preference when a plurality of types of meal items are available (such as when both a main dish and a dessert are available for selection), and plans the meal item for use as the dessert. Foreseeable advantages of present disclosure include high flexibility and popularity with users.

A further advantage is that, after inferring users' (and the general public's) preference for different categories of food automatically, a system undertakes continuous learning based on a track record without manually being informed by the users what food the users want to eat. As a result of the inference and learning process, users are more likely to comply with the outcome of diet planning.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present disclosure may be embodied as a computer device, a method or a computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

The present embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

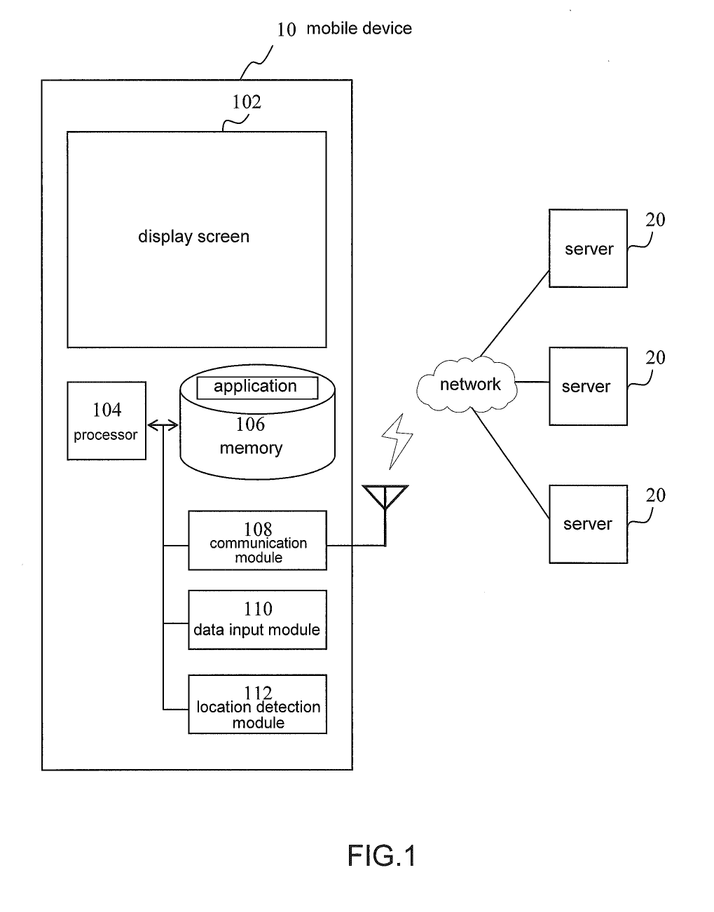

Referring generally now to FIG. 1 through FIG. 5, embodiments of a system, devices, methods, and computer program products are illustrated as structural or functional block diagrams or process flowcharts. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 1 is a block diagram of a mobile device 10 in an embodiment. The mobile device 10 comprises a display screen 102, a processor 104, a memory 106, a communication module 108, a data input module 110, and a location detection module 112.

It will be noted that the mobile device 10 can be implemented in the form of a conventional notebook computer or a similar portable information device. For example, the mobile device 10 may a mobile phone whose basic structure can be understood with reference to iPhone™ of Apple™.

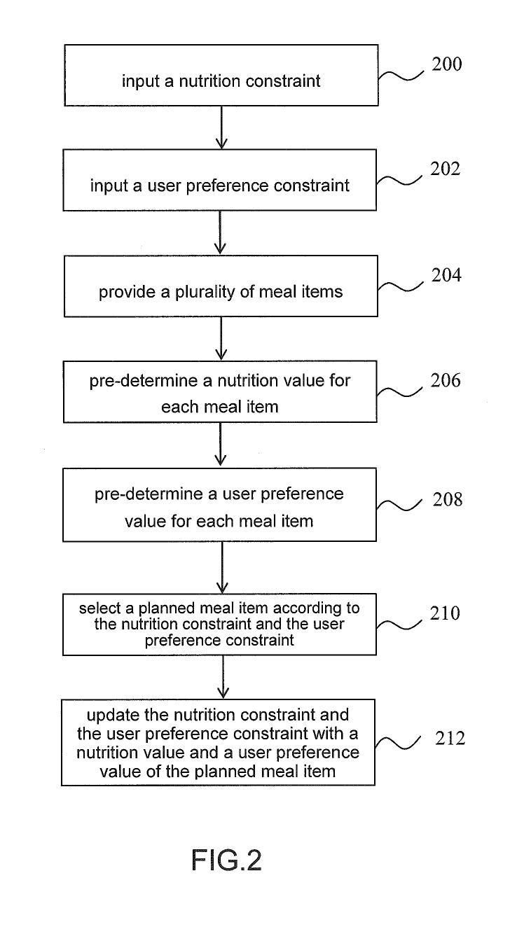

For example, the processor 104 is a central processor manufactured by ARM™ and configured for use with the mobile device. The memory 106 is a flash memory for storing an application AP and can be accessed by the processor 104 and executed. Reference may be made to existing applications executed on iPhone™ for the basic implementation aspects of the application AP. Functions provided by the application AP are hereunder illustrated with FIG. 2 through FIG. 5.

The communication module 108 is capable of providing network connection with UMTS, GSM, or Wi-Fi and thus capable of being connected to one or more servers 20. The data input module 110 can be a digital camera module for inputting image data or barcode data. Alternatively, the data input module 110 is integrated with the display screen 102 to form a touchscreen whereby a user inputs data. The location detection module 112 can be a GPS module for providing the location of the mobile device 10. In addition to the GPS module, the location detection module 112 provides the location of the mobile device 10 by means of UMTS, GSM, or Wi-Fi to which the communication module 108 is connected. The present invention is not restrictive of the accuracy of location detection performed by the location detection module 112.

FIG. 2 is a flowchart of an embodiment of the present invention. An embodiment of an automatic diet planning method is hereunder illustrated with FIG. 2 and the mobile device 10 shown in FIG. 1.

Block 200: inputting a nutrition constraint on a type of nutrition. In this block, a user inputs a nutrition constraint on a specific type of nutrition with the data input module 110 of the mobile device 10 or downloads a nutrition constraint on a specific type of nutrition online.

For example, the user can set a maximum calorie of 700 kcal allowable in each meal or set a minimum vitamin C content of 400 mg required for each meal. For setting a nutrition constraint, reference may be made to recommendations set forth by a health authority of a government, such as for example Dietary Reference Intakes: Recommended Intakes for Individuals published on the official website of United States Department of Agriculture (USDA). Alternatively, the user may set a nutrition constraint as needed. It should be noted that, in Block 200, the user may set nutrition constraints on a plurality of types of nutrition, respectively.

Block 202: inputting a preference constraint on a type of user preference. In this block, the user inputs a preference constraint on a type of user preference with the data input module 110 of the mobile device 10 or downloads a preference constraint on a type of user preference online.

First, it should be noted that the user preference has nothing to do with nutrition. In general, the user preference not only varies from user to user, but also depends on time, location, and scenario when the same user is considered. For example, the types of user preferences may include, but are not limited to, taste (sweetness or spiciness), place of origin (American beef or Australian beef), and budget (cost). It should be noted that, in Block 202, the user may set preference constraints on a plurality of types of user preference, respectively.

To effectuate automation, it is necessary to denote the user's preference constraint with a numerical value. For example, regarding “sweetness,” the user may choose a numerical value from within the range between 0 and 1, with 0 indicating low sweetness and 1 indicating high sweetness, wherein numerical values between 0 and 1 indicate different degrees of moderate sweetness. Regarding “budget,” numerical value 0 denotes inexpensive, and numerical value 1 denotes expensive. For a user preference which cannot be described by gradation, such as the place of origin (American beef), the user can choose 0 or 1, with 0 indicating the absence of the preference and 1 indicating the presence of the preference. It should be noted that the aforesaid way of choosing numerical values based on 0 and 1 is illustrative, rather than restrictive, of the present invention, and thus the present invention may employ any other numerical values which can be used in numerical computation.

Block 204: providing a plurality of meal items. In an embodiment, the application AP creates a built-in database in advance for recording a plurality of meal items. Alternatively, in another embodiment, the aforesaid database is disposed at the servers 20 at a remote end, that is, the “cloud,” and is accessible by the application AP via a network.

Block 206: pre-determining a nutrition value for each meal item regarding the type of nutrition. In this block, a plurality of fields which relate to the meal items, respectively, are provided in the aforesaid database, and one of the fields is intended for a specified type of nutrition (such as calorie or vitamin C) in order to record a related nutrition value. The table below illustrates an example.

| Meal Item | Calorie (kcal) | Vitamin C (mg) |
|---|---|---|
| seafood A | 600 | 350 |
| steak A | 700 | 200 |
| steak B | 650 | 250 |
| ice cream A | 200 | 50 |
| cake A | 80 | 150 |

Block 208: pre-determining a preference value for each meal item regarding the user preference. In this block, a plurality of fields which relate to the meal items, respectively, are provided in the aforesaid database, and one of the fields is intended for a specified type of user preference (such as budget or place of origin: American beef) in order to record a related preference value. The table below illustrates an example.

| Meal Item | Budget | American Beef |
|---|---|---|
| seafood A | 0.7 | 0 |
| steak A | 0.7 | 0 |
| steak B | 0.6 | 1 |
| ice cream A | 0.2 | 0 |
| cake A | 0.1 | 0 |

Block 210: selecting at least one planned meal item from the plurality of meal items according to the nutrition constraint and the preference constraint, wherein the planned meal item has the nutrition value and the preference value respectively complying with the nutrition constraint and the preference constraint. For example, if the nutrition constraint thus input in Block 200 is: calorie less than 700 kcal, vitamin C more than 150 mg and a preference constraint thus input in Block 202 is: budget: a preference value that ranges between 0.5 and 0.9, whereas a nutrition value and a preference value of “a combination of seafood A and cake A” or steak B satisfy the aforesaid constraints, the application AP will treat “a combination of seafood A and cake A” and steak B as the planned meal items and recommend them to the user.

It is feasible to treat a single meal item or a combination of multiple meal items as a planned meal item, which is not limited by the present invention. However, the total nutrition value of a combination of multiple meal items usually has to satisfy the nutrition constraint input in Block 200. Optionally, for some specific user preference constraints (such as budget), the total preference value of a combination of multiple meal items also has to satisfy a preference constraint input in Block 202. In fact, not all preference values are suitable for addition. For example, preference values pertaining to “sweetness” are not suitable for addition. Conversely, nutrition values are always suitable for addition. For those preference values which are not suitable for addition, the preference value of each meal item among a combination of multiple meal items has to comply with a preference constraint. In this regard, it is also feasible to require that the nutrition value of each meal item among a combination of multiple meal items has to comply with the nutrition constraint in order to meet user needs.

In another variant embodiment, the user presets cake A to be a specified meal item among a plurality of meal items provided in Block 204. For example, the user gets fascinated with cake A after seeing a picture taken of cake A shown on a menu in a restaurant, and then the user inputs cake A to the application AP with the data input module 110 of the mobile device 10 so as to set a specified meal item to cake A. Cake A can be input to the application AP in plenty of ways. For example, the user can either key in the name of cake A by hand or retrieve an image or a corresponding barcode of cake A and identify the image or the barcode with the application AP, which are not limited by the present invention. Besides, the present invention is not restrictive of the way of selecting a specified meal item by the user.

After the specified meal item cake A has been input to the application AP, Block 210 starts. Since only “the combination of seafood A and cake A” can satisfy the user regarding the nutrition constraint and the preference constraint in Block 200 and Block 202, respectively, the application AP only sees “the combination of seafood A and cake A” that includes the specified meal item (i.e. cake A) as a planned meal item. By contrast, although steak B satisfies the user regarding the nutrition constraint and the preference constraint in Block 200 and Block 202, respectively, it does not become a planned meal item, because it does not include the specified meal item (i.e. cake A).

Block 212: if the user is satisfied with steak B of the planned meal item, the application AP will store a nutrition value and a preference value of steak B in the memory 106. Optionally, to carry out the diet planning method again, it is feasible that a nutrition value and a preference value of steak B are directly regarded as the nutrition constraint and the preference constraint in Block 200 and Block 202, respectively, and thus the planned meal item thus selected in Block 210 meets the user's need better.

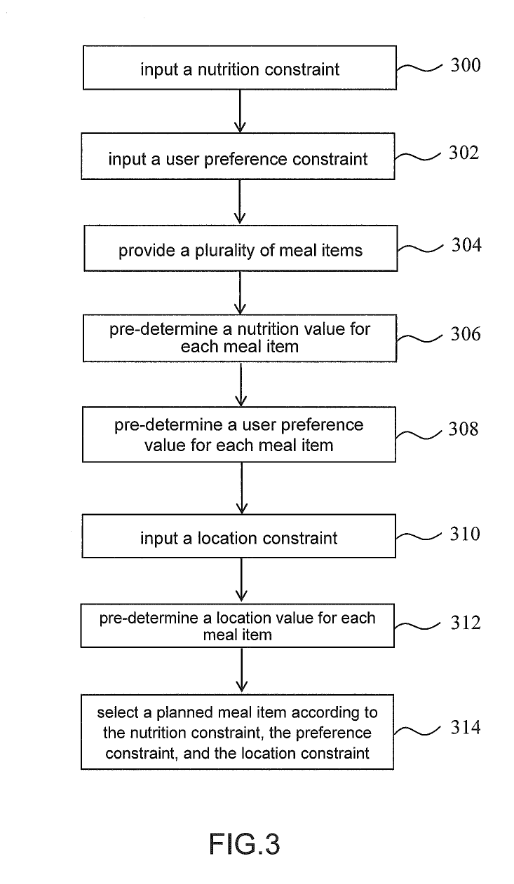

FIG. 3 is a flowchart of an embodiment of the present invention. FIG. 3, coupled with the mobile device 10 shown in FIG. 1, illustrates an embodiment of an automatic diet planning method. In particular, the embodiment illustrated with FIG. 3 applies to eating out.

Block 300 through Block 308: the blocks correspond to the aforesaid Block 200 through Block 208, respectively, and thus are not described in detail herein for the sake of brevity.

Block 310: inputting a location constraint on a type of user location. In this block, the user inputs a location constraint on the user's location with the data input module 110 of the mobile device 10. The location constraint comes in the form of an address, such as “Taipei City,” “Daan District, Taipei City,” or “Dunhua S. Rd., Daan District, Taipei City”. Alternatively, the user detects the longitude and latitude of the user's location with a location detection module 112 (such as the GPS module) of the mobile device 10 and sets the area within a boundary less than a specific distance from the user's location to the location constraint.

For example, assuming the user is in front of the Taipei City Hall right now, the GPS module 112 detects that the user's location lies at 25.03823 latitude and 121.563967 longitude, and thus the application AP sets the area within a boundary less than 1 km from the aforesaid location to the location constraint.

Block 312: pre-determining a location value for each meal item. In this block, the aforesaid database can record a location value for each meal item. In this embodiment, it is the location value of the restaurant which offers the meal item. The table below illustrates an example.

| | | Restaurant's |
|---|---|---|
| Meal Item | Restaurant's Address | Longitude and Latitude |
| seafood A | Road B, District A, Taipei City | (X1; Y1) |
| steak A | Road B, District A, Taipei City | (X1; Y1) |
| steak B | Road E, District D, Taichung | (X3; Y3) |
| | City | |
| ice cream A | Road G, District F, Taipei City | (X4; Y4) |
| cake A | Road H, District H, Tainan City | (X5; Y5) |

Block 314: selecting at least one planned meal item from the plurality of meal items according to a nutrition constraint, a preference constraint, and a location constraint, wherein a nutrition value, a preference value, and a location value of the planned meal item comply with the nutrition constraint, the preference constraint, and the location constraint, respectively. Please refer to the above description of Block 210 for details of nutrition and a type of user preference.

Regarding determining compliance with a location constraint, if the location constraint is expressed by an address, it will be necessary to determine whether a location value contains an address specified in the location constraint. If the location constraint is expressed by longitude and latitude, it will be necessary to determine whether the distance between the longitude and latitude of a location value and the longitude and latitude specified in the location constraint falls within a specific range of distance.

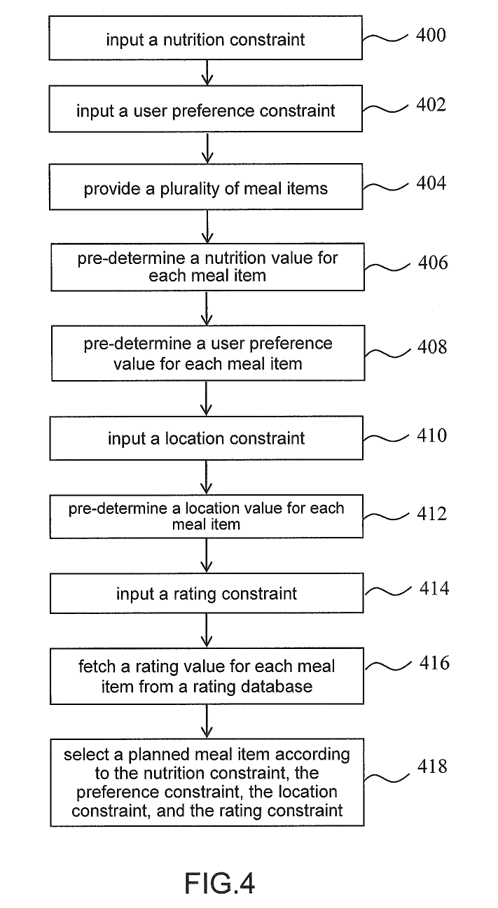

FIG. 4 is a flowchart of an embodiment of the present invention. FIG. 4, coupled with the mobile device 10 shown in FIG. 1, illustrates an embodiment of an automatic diet planning method. In particular, the embodiment illustrated with FIG. 4 applies to ordering food in a specific restaurant.

Block 400 through Block 412: the blocks correspond to the aforesaid Block 300 through Block 312, respectively, and thus are not described in detail herein for the sake of brevity. The examples below are illustrated with meal items (i.e. seafood A and steak A) offered by the same restaurant. However, the present invention is not limited to meal items offered by the same restaurant.

Block 414: inputting a rating constraint on a type of meal rating. In this block, the user inputs a rating constraint on a type of meal rating with the data input module 110 of the mobile device 10. For example, the user may choose a numerical value from within the range between 0 and 1 to denote a rating, with 0 indicating a low rating and 1 indicating a high rating. Alternatively, the user may choose an integer value from 1 through 5, and doing so parallels some famous star rating systems, with five stars indicating the highest rating. It should be noted that, in Block 414, it is feasible to set rating constraints on multiple ratings, respectively.

Block 416: fetching a rating value for each meal item from a rating database. In this block, the mobile device 10 fetches a rating value of seafood A and steak A from the servers 20 at a remote end. The rating value can be obtained from other sources. For example, plenty of travel guides or restaurant guides give ratings to meal items, and plenty of social networking websites allow customers to rate restaurants or meals. The table below illustrates an example.

| meal item | guide rating (0-1) | customer rating (1-5) |
|---|---|---|
| seafood A | 0.6 | 2 |
| steak A | 0.8 | 3 |

Block 418: selecting at least one planned meal item from the plurality of meal items according to a nutrition constraint, a preference constraint, a location constraint, and a rating constraint, wherein a nutrition value, a preference value, a location value, and a rating value of the planned meal item respectively comply with the nutrition constraint, the preference constraint, the location constraint, and the rating constraint. For example, if a rating constraint thus input in the aforesaid Block 414 is a guide rating value being larger than 0.7 and a customer rating value being larger than 2, the application AP will select steak A as the planned meal item (assuming that the nutrition value, the preference value, and the location value of steak A comply with their respective constraints).

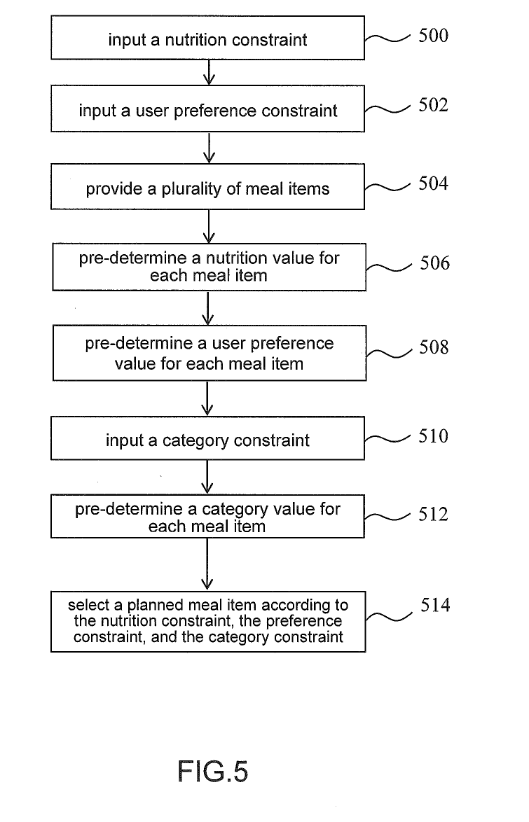

FIG. 5 is a flowchart of an embodiment of the present invention. FIG. 5, coupled with the mobile device 10 shown in FIG. 1, illustrates an embodiment of an automatic diet planning method. In particular, the embodiment illustrated with FIG. 5 applies to a scenario where there is a special need for a meal category.

Block 500 through Block 508: the blocks correspond to the aforesaid Block 200 through Block 208, respectively, and thus are not described in detail herein for the sake of brevity.

Block 510: inputting a category constraint on a plurality of meal categories. In this block, the user inputs a category constraint on meal categories with the data input module 110 of the mobile device 10. First, it should be noted that the meal categories have nothing to do with nutrition. For example, meal categories include a “main dish” and a “dessert”. Alternatively, meal categories include “Italian cuisine” and “Japanese cuisine,” or are ones which have nothing to do with nutrition. In this block, the user can set an allowable number of meal items in each category (that is, the sum of category values of the category).

Block 512: pre-determining a category value for each meal item in a meal category. In this block, in the aforesaid database, multiple fields are provided for meal items in a manner that the fields correspond to a meal category. Where the meal items are attributed to a specific meal category (such as “main dish”), the main dish field contains the category value 1, and other category values (such as “dessert”) are 0. Conversely, where a meal item is a “dessert,” the dessert field contains the category value 1, and the category value in the main dish field is 0. The table below illustrates an example.

| | category value | category value |
|---|---|---|
| meal item | (main dish) | (dessert) |
| seafood A | 1 | 0 |
| steak A | 1 | 0 |
| steak B | 1 | 0 |
| ice cream A | 0 | 1 |
| cake A | 0 | 1 |

Block 514: selecting at least one planned meal item from the plurality of meal items according to the nutrition constraint, the preference constraint, and the category constraint, wherein a nutrition value, a preference value, and a category value of the planned meal item comply with the nutrition constraint, the preference constraint, and the category constraint, respectively. Reference may be made to the description of the aforesaid Block 210 for details of nutrition and a type of user preference.

For example, regarding determining compliance with the category constraint thus input in Block 510, if a category value of “main dish” equals 0 and a category value of “dessert” is larger than 0, ice cream A, cake A, or a combination of ice cream A and cake A will be selected to be the planned meal item (assuming both a nutrition value and a preference value satisfy their respective constraints). In this situation, none of seafood A, steak A, and steak B will be selected to be the planned meal item, even if their nutrition value and preference value satisfy their respective constraints.

For example, regarding the category constraint thus input in Block 510, if a category value of “main dish” equals 1 and a category value of “dessert” equals 1, it will be foreseeable that the planned meal item does not contain two or more “main dishes” or two or more “desserts”. The above-mentioned is usually a taboo in food ordering.

The automatic diet planning method proposed in the above embodiments not only requires a nutrition constraint but also gives considerations to a preference constraint and other constraints which are not related to nutrition. In doing so, the automatic diet planning method of the present invention is personalized when it comes to diet planning, because people can hardly accept nutrition-based diet planning.

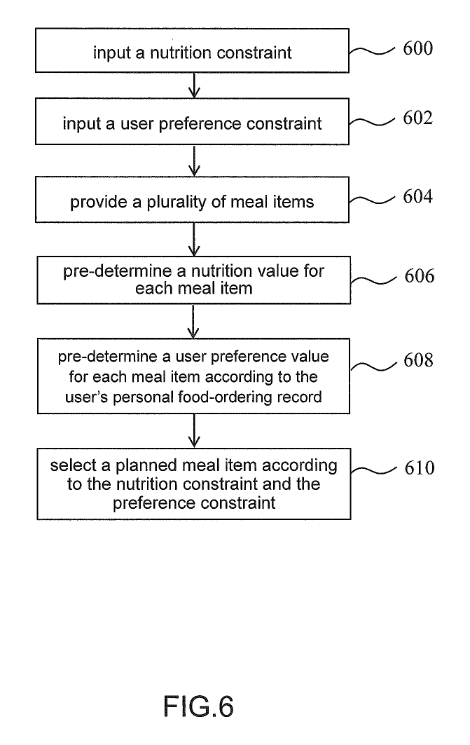

FIG. 6 is a flowchart of an embodiment of the present invention. FIG. 6, coupled with the mobile device 10 shown in FIG. 1, illustrates an embodiment of an automatic diet planning method. In particular, the embodiment illustrated with FIG. 6 can be regarded as an extended variant of the aforesaid fourth embodiment, and applies to ordering food in a specific restaurant. Blocks 600, 604, 606 of FIG. 6 substantially correspond to Blocks 500, 504, 506 of FIG. 5, respectively, and thus are not described in detail herein for the sake of brevity.

Block 602: as with Block 202 or Block 502, Block 602 involves inputting with the data input module 110 of the mobile device 10 or downloading online by the user a preference constraint on a type of user preference. But what makes Block 602 unique is that the preference constraint of Block 602 may relate to the user's food-ordering experience. For example, the preference constraint (the number of instances of selecting a specific meal category (such as seafood)/the total number of instances of selecting meal items) is set to being larger than a specific value or being a maximum value. To ensure ease of description, in the embodiment of FIG. 6, a meal category is divided into “seafood,” “steak,” and “pasta” (which can be seen as sub-categories of a main dish), which are different from the exemplary categories of FIG. 5. Furthermore, preferably, in this block, the maximum value of a preference value for each meal item is automatically regarded as the preference constraint, and thus the user need not input a preference constraint.

Block 608: calculating the number of instances the user selects a category value according to the user's personal food-ordering record, followed by setting a preference value according to the number of instances. The table below illustrates an example.

| | category | category | category | preference |
|---|---|---|---|---|
| | value | value | value | value |
| meal item | (seafood) | (steak) | (pasta) | (personal) |
| seafood A | 1 | 0 | 0 | 0.4 |
| steak A | 0 | 1 | 0 | 0.5 |
| steak B | 0 | 1 | 0 | 0.5 |
| pizza A | 0 | 0 | 1 | 0.1 |
| spaghetti A | 0 | 0 | 1 | 0.1 |

As shown in the table above, both steak A and steak B are always regarded as steak in terms of a meal category, and thus the category value (steak) of steak A and steak B is 1, and the user preference value corresponding to the category value (steak) is 0.5; in other words, in roughly 50 out of 100 instances of food ordering, the user chose a meal item in the steak category. Both pizza A and spaghetti A are always regarded as pasta in terms of a meal category, and thus the category value (pasta) of pizza A and spaghetti A is 1, and the user preference value corresponding to the category value (pasta) is 0.1; in other words, in roughly 10 out of 100 instances of food ordering, the user chose a meal item in the pasta category.

It should be noted that feasible statistical methods pertaining to generating a preference value from the user's food-ordering record include frequency method (similar to term frequency in information search), weighted frequency method (similar to TF-IDF in information search), and collaborative filtering, which are not limited by the present invention.

Block 610: similar to Block 210, Block 610 involves selecting at least one planned meal item from the plurality of meal items according to the nutrition constraint and the preference constraint, wherein a nutrition value and a preference value of the planned meal item comply with the nutrition constraint and the preference constraint, respectively. For example, regarding the preference constraint thus input in Block 602, if the preference value is larger than 0.4 or the maximum preference value (0.5) is automatically regarded as the preference constraint, the application AP will select steak A and steak B to be the planned meal item and recommend steak A and steak B to the user, because the preference value (0.5) of steak A and steak B complies with the aforesaid constraint (assuming that the nutrition value of steak A and steak B complies with the constraint). Hence, when ordering food in a specific restaurant, the user can rapidly select a meal item that complies with the user's personal nutrition constraint and personal eating habits.

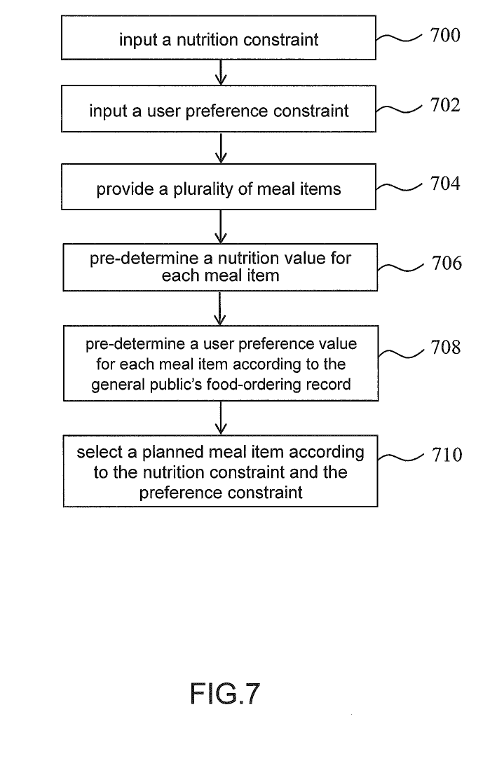

FIG. 7 is a flowchart of an embodiment of the present invention. FIG. 7, coupled with the mobile device 10 shown in FIG. 1, illustrates an embodiment of an automatic diet planning method. In particular, the embodiment illustrated with FIG. 7 can be regarded as another extended variant of the aforesaid fifth embodiment and applies to ordering food in a specific restaurant. Blocks 700, 704, 706 of FIG. 7 substantially correspond to the aforesaid Blocks 600, 604, 606 of FIG. 6, respectively, and thus are not described in detail herein for the sake of brevity.

Block 702: as with Block 602, Block 702 involves inputting with the data input module 110 of the mobile device 10 or downloading online by the user a preference constraint on a type of user preference. But what makes Block 702 unique is that the preference constraint of Block 702 may relate to the food-ordering experience of a plurality of other users (such as the general public or members of a specific group) rather than the user, wherein the accuracy in assessment of ordinary persons' (general public's) preference increases with the number of the other users. As with Block 602, Block 702 involves setting the preference constraint (the number of instances of selecting a specific meal category/the total number of instances of selecting meal items) to being larger than a specific value. Preferably, Block 702 involves setting the preference constraint to the maximum value of a preference value for each meal item automatically, and thus the user need not input a preference constraint.

Block 708: calculating the number of instances the other users select a category value according to a food-ordering record of a plurality of other users (general public), followed by setting a preference value according to the number of instances. The table below illustrates an example.

| | category | category | category | preference |
|---|---|---|---|---|
| | value | value | value | value |
| meal item | (seafood) | (steak) | (pasta) | (general public) |
| seafood A | 1 | 0 | 0 | 0.8 |
| steak A | 0 | 1 | 0 | 0.15 |
| steak B | 0 | 1 | 0 | 0.15 |
| pizza A | 0 | 0 | 1 | 0.05 |
| spaghetti A | 0 | 0 | 1 | 0.05 |

As shown in the table above, seafood A is always regarded as seafood in terms of a meal category, and thus the category value (seafood) of seafood A is 1, and the user preference value corresponding to the category value (seafood) is 0.7; in other words, in roughly 7000 out of 10000 instances of food ordering, the other users (general public) chose a meal item in the seafood category.

Block 710: similar to Block 610, Block 710 involves selecting at least one planned meal item from the plurality of meal items according to the nutrition constraint and the preference constraint, wherein a nutrition value and a preference value of the planned meal item comply with the nutrition constraint and the preference constraint, respectively. For example, regarding the preference constraint thus input in Block 702, if the preference value is larger than 0.5 or the maximum preference value (0.8) is automatically regarded as the preference constraint, the application AP will select seafood A to be the planned meal item and recommend seafood A to the user, because the preference value (0.8) of seafood always satisfies the aforesaid constraint (assuming that the nutrition value of seafood A complies with the constraint). In this embodiment, when ordering food in a specific restaurant, the user can rapidly select a meal item that complies with the user's personal nutrition constraint and is popular with the general public.

Furthermore, in an embodiment not shown, the embodiments of FIG. 6 and FIG. 7 are further combined, such that the application AP selects a planned meal item according to the user's personal nutrition constraint and personal preference (based on the user's food-ordering record) and the general public's taste (based on the general public's food-ordering record) and then recommends the planned meal item to the user.

In the aforesaid embodiments, all the multiple constraints used in diet planning are expressed by numerical values, and thus optimization can be achieved in a numerical manner. As described above, each of the aforesaid embodiments involves the use of at least two constraints, and thus conventional “Multi-Objective Optimization” is applicable to the present invention.

For more details of “Multi-Objective Optimization,” reference may be made to US2009/0192973, filed by the applicant, or to Wikipedia™ Webpage http://en.wikipedia.org/wiki/Multiobjective_optimization. Further, the present embodiments is not intended to be restrictive of a solution of “Multi-Objective Optimization”. For example, “Pareto optimal” is applicable to the present embodiments. For more details of “Pareto optimal,” reference may be made to US2003/0204466, filed by the applicant, or to Wikipedia™ Webpage http://en.wikipedia.org/wiki/Pareto_efficiency. Furthermore, it is also feasible that different numerical constraints have their respective weights, such that “Multi-Objective Optimization” can be attained by an “analytical hierarchy process (AHP)”. Reference may be made to Wikipedia™ Webpage http://en.wikipedia.org/wiki/Analytic Hierarchy Process) for details of an “analytical hierarchy process (AHP)”.

The foregoing embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

What is claimed is:

1. An automatic diet planning method, comprising:
receiving, by a computing device, user input of a nutrition constraint on a type of nutrition;
receiving user input of a preference constraint on a type of user preference, wherein the user preference has nothing to do with nutrition;
providing to the user a plurality of meal items;
pre-determining a nutrition value for each meal item regarding the type of nutrition;
pre-determining a preference value for each meal item regarding the user preference; and
receiving from the user a selection of at least one planned meal item from the plurality of meal items according to the nutrition constraint and the preference constraint, wherein the planned meal item has the nutrition value and the preference value respectively complying with the nutrition constraint and the preference constraint.

2. The method of claim 1, further comprising:
receiving user input of a rating constraint on a type of meal rating; and
fetching a rating value for each meal item from a rating database,
wherein the rating value of the planned meal item complies with the rating constraint.

3. The method of claim 1, further comprising:
receiving user input of a category constraint on a plurality of meal categories, wherein the meal categories have nothing to do with nutrition; and
pre-determining a category value for each meal item regarding the meal category, wherein the category value of the planned meal item complies with the category constraint.

4. The method of claim 1, further comprising:
updating the nutrition constraint further according to a nutrition value of the planned meal item or updating the preference constraint further according to a preference value of the planned meal item.

5. The method of claim 1, further comprising:
receiving user input of a location constraint on a type of user location; and
pre-determining a location value for each meal item,
wherein the location value of the planned meal item complies with the location constraint.

6. The method of claim 1, wherein a specified meal item is selected from the plurality of meal items prior to the step of selecting at least one planned meal item, and selecting at least one planned meal item, a sum of a nutrition value of the planned meal item and a nutrition value of the specified meal item complies with the nutrition constraint.

7. The method of claim 6, wherein a sum of the preference value of the planned meal item and the preference value of the specified meal item complies with the preference constraint.

8. The method of claim 1, further comprising:
pre-determining a category value for each meal item regarding a plurality of meal categories, wherein the plurality of meal categories have nothing to do with nutrition,
wherein the pre-determining a preference value for each meal item further comprises:
calculating a number of instances the user selects the category value according to a food-ordering record of the user, followed by setting the preference value according to the number of instances.

9. The method of claim 1, further comprising:
pre-determining a category value for each meal item regarding a plurality of meal categories, wherein the plurality of meal categories have nothing to do with nutrition,
wherein the pre-determining a preference value for each meal item further comprises:
calculating a number of instances a plurality of other users select the category value according to a food-ordering record of the plurality of other users, followed by setting the preference value according to the number of instances.

10. The method of claim 8, wherein inputting the preference constraint further comprises:
searching automatically for a maximum value of a preference value for each meal item, followed by treating the maximum value as the preference constraint.

11. A mobile device, comprising:
a memory configured to store an application; and
a processor configured to access the memory to execute the application, the application implementing a, automatic diet planning method, wherein the method comprises:
receiving user input of a nutrition constraint on a type of nutrition;
receiving user input of a preference constraint on a type of user preference, wherein the user preference has nothing to do with nutrition;
providing to the user a plurality of meal items;
pre-determining a nutrition value for each meal item regarding the type of nutrition;
pre-determining a preference value for each meal item regarding the user preference; and
receiving from the user a selection of at least one planned meal item from the plurality of meal items according to the nutrition constraint and the preference constraint, wherein the planned meal item has the nutrition value and the preference value respectively complying with the nutrition constraint and the preference constraint.

12. The mobile device of claim 11, wherein the memory stores a preference value and a nutrition value pre-determined for each meal item and the plurality of meal items.

13. The mobile device of claim 11, further comprising:
a communication module connected to a server,
wherein the processor executes the application and fetches a preference value and a nutrition value pre-determined for each meal item and the plurality of meal items from the server via the communication module.

14. The mobile device of claim 11, further comprising:
a communication module connected to a server,
wherein the processor executes the application and further performs:
inputting a rating constraint on a type of meal rating; and
fetching a rating value for each meal item from the server via the communication module,
wherein, in the step of selecting at least one planned meal item, the rating value of the planned meal item complies with the rating constraint.

15. The mobile device of claim 11, further comprising:
a location detection module configured to provide a location of the mobile device,
wherein the processor executes the application and further performs the steps of:
receiving a user input of a location constraint on the location; and
pre-determining a location value for each meal item,
wherein the location value of the planned meal item complies with the location constraint.

16. The mobile device of claim 15, wherein the memory further stores the pre-determined location value for each meal item.

17. The mobile device of claim 15, further comprising:
a communication module connected to a server,
wherein the processor executes the application and fetches the pre-determined location value for each meal item from the server via the communication module.

18. The mobile device of claim 11, further comprising:
a data input module wherein the user selects a specified meal item from the plurality of meal items prior to selecting at least one planned meal item,
wherein, in selecting at least one planned meal item, a sum of a nutrition value of the planned meal item and a nutrition value of the specified meal item complies with the nutrition constraint.

19. The mobile device of claim 11, wherein the processor executes the application and further updates the nutrition constraint according to a nutrition value of the planned meal item or further updates the preference constraint according to a preference value of the planned meal item.
